(19) United States
(12) Patent Application Publication
(10) Pub. No.: US 2026/0080352 A1
(43) Pub. Date: Mar. 19, 2026

(54) SYSTEMS AND METHODS FOR ESTIMATING DYNAMIC TIME WINDOW FOR LAST-MILE DELIVERY ESTIMATED TIME OF ARRIVAL

(71) Applicant: BNSF Railway Company, Fort Worth, TX (US)

(72) Inventors: Thurston Dixon, Fort Worth, TX (US); April Y. Kuo, Colleyville, TX (US); Wenjie Li, Grapevine, TX (US); Jeremy Stenvold, Minot, ND (US); Thomas C. Simmons, Trophy Club, TX (US)

(73) Assignee: BNSF Railway Company, Fort Worth, TX (US)

(21) Appl. No.: 19/285,774

(22) Filed: Jul. 30, 2025

Related U.S. Application Data
(60) Provisional application No. 63/677,255, filed on Jul. 30, 2024.

(51) Int. Cl. G06Q 10/0833

(52) U.S. Cl. CPC G06Q 10/0833

(57) ABSTRACT

Systems and techniques for generating an enhanced estimated time of arrival (ETA) with a dynamic time window for last-mile delivery. A system includes an enhanced ETA model that ingests data from disparate data signals including historical data signals, projected traffic signals, and/or real-time signals. The enhanced ETA model considers station dwell time and travel time when generating the enhanced ETA. The system standardizes the format of ingested data and converts non-formatted data into a standardized format. The enhanced ETA model includes a station dwell time model to predict dwell time of trains within a station and a train travel time model to predict expected travel time from a source to a destination. The system generates a control signal based on the enhanced ETA to actuate movement of equipment. The dynamic time window of the enhanced ETA becomes smaller as the train approaches the destination.

### CROSS-REFERENCE TO RELATED APPLICATIONS

The present application claims priority to U.S. Provisional App. No. 63/677,255, filed Jul. 30, 2024, the disclosure of which is hereby incorporated by reference in its entirety for all purposes.

### TECHNICAL FIELD

The present disclosure relates generally to estimated arrival times (ETA) systems, and more particularly to systems and methods for generating an enhanced ETA with a dynamic time window for last-mile delivery in rail transportation.

### BACKGROUND

Rail intermodal transportation plays a crucial role in the modern supply chain, combining the efficiency of rail with the flexibility of truck transport. This mode of freight transportation involves the movement of containers from one point to another using trains, typically serving as the middle mile segment in a broader logistics network. The integration of rail intermodal with first and last mile truck transportation is essential for creating a resilient, efficient, and consistent end-to-end supply chain.

A critical component of this integrated system is the last mile delivery process, which involves transporting goods from a rail terminal to a customer facility. Central to this process is the estimated time of arrival (ETA), which provides an expected time for when a train will reach its destination. The accuracy of this ETA is of paramount importance, as it directly impacts customer satisfaction, resource utilization, and operational efficiency.

Customers rely heavily on ETAs to schedule their resources and operations. When customer systems are integrated with the supply chain system, they use the provided ETA to plan their activities accordingly. Similarly, local operators need accurate ETAs to ensure they have crews in place when trains arrive, avoiding situations where additional crews must be called in due to unexpected delays. Traffic managers also depend on reliable ETA information to plan equipment needs and cycle times, determining how long equipment will be on the rail network and at intermodal hub facilities.

However, predicting ETAs for rail last mile delivery faces several challenges. These include uncertainties in train dwell time at terminals, variability in transit time from terminals to customer facilities, and limitations in loading and unloading resource availability. These factors can lead to delays, inefficient supply chain integration, suboptimal train set utilization, and increased costs for both operators and customers.

Current systems provide ETAs for trains as single time stamps. For example, current systems provide ETAs as a static date/time value of when the train is expected to arrive at its destination. In addition, this static approach to ETA estimation often relies on guesswork and lacks a robust mechanism for calculation, estimation, or refinement of the ETA. As a result, the accuracy and reliability of these ETAs are limited, potentially leading to disruptions in the supply chain and inefficiencies in resource allocation.

### BRIEF SUMMARY

The present disclosure achieves technical advantages as systems, methods, and computer-readable storage media that provide functionality for generating generate an enhanced estimated time of arrival (ETA) that includes a dynamic time window for a last-mile delivery ETA.

In embodiments, an enhanced ETA system may operate by ingesting and processing various data signals, including historical data, projected traffic information, real-time data, etc. The enhanced ETA system may utilize advanced modeling techniques, incorporating artificial intelligence and machine learning algorithms, to analyze complex patterns and relationships in the data. This functionality may enable the system to generate a dynamic time window for arrival estimates, which may adapt and narrow as the train approaches its destination. By leveraging diverse data sources and enhanced modeling, the system may provide increasingly accurate predictions throughout the journey, potentially improving resource allocation, operational efficiency, and overall supply chain integration in rail transportation and last-mile delivery operations.

The advantageous result of the present disclosure includes several technical improvements over conventional ETA systems. For example, the dynamic time window of embodiments overcomes the problems with traditional static ETAs, as the dynamic time window of embodiments includes a flexible time range for arrival estimates. This dynamic window adapts and narrows as the train approaches its destination, providing increasingly accurate predictions. Additionally, the enhanced ETA system of embodiments incorporates artificial intelligence and/or machine learning algorithms, enabling the system to analyze complex patterns and relationships in the data, leading to more accurate and reliable ETA predictions.

Another technical improvement provided by the system of embodiments is the segment-based approach for train travel time estimation, which overcomes the limitations presented by scarce data for specific routes. This functionality may enable more accurate predictions even for new or infrequently traveled routes. In addition, the system of embodiments may generate control signals for managing physical assets based on the enhanced ETA, allowing for automated or guided positioning of equipment in preparation for train arrivals.

Thus, it will be appreciated that the technological solutions provided herein, and missing from conventional systems, are more than a mere application of a manual process to a computerized environment, but rather include functionality to implement a technical process to replace or supplement current manual solutions or non-existing solutions for estimating ETAs. In doing so, the present disclosure goes well beyond a mere application the manual process to a computer. Accordingly, the claims herein necessarily provide a technological solution that overcomes a technological problem.

In various embodiments, the system comprises one or more processors interconnected with a memory module, capable of executing machine-readable instructions. These instructions include, but are not limited to, the steps outlined in any flow diagram, system diagram, block diagram, and/or process diagram disclosed herein, as well as steps corresponding to any functionality detailed herein. In embodiments, the execution of these machine-readable instructions may involve initiating multiple concurrent computer processes. Each process of the concurrent computer process may be configured to handle or process a designated subset or portion of the of the machine-readable instructions. This division of tasks enables parallel processing, multi-processing, and/or multi-threading, enabling multiple operations to be conducted or executed concurrently rather than sequentially. This functionality for spawning a plurality of concurrent processes to manage separate portions of the machine-readable instructions markedly increases the overall speed of execution of the machine-readable instructions. By leveraging parallel or concurrent processing, the time required to complete a set or subset of program steps is substantially reduced (e.g., when compared to execution without concurrent or parallel processing). This efficiency gain not only accelerates the processing speed but also optimizes the use of processor resources, leading to an improved performance of the computing system. This enhancement in computational efficiency constitutes a significant technological improvement, as it enhances the functional capabilities of the processors and the system as a whole, representing a practical and tangible technological advancement. The result of this concurrent processing functionality results in an improvement in the functioning of the one or more processor and/or the computing system, and thus, represents a practical application.

In embodiments, the present disclosure includes techniques for training models (e.g., machine-learning models, artificial intelligence models, algorithmic constructs, etc.) for performing or executing a designated task or a series of tasks (e.g., one or more features of steps or tasks of processes, systems, and/or methods disclosed in the present disclosure). The disclosed techniques provide a systematic approach for the training of such models to enhance performance, accuracy, and efficiency in their respective applications. In embodiments, the techniques for training the models may include collecting a set of data from a database, conditioning the set of data to generate a set of conditioned data, and/or generating a set of training data including the collected set of data and/or the conditioned set of data. In embodiments, that model may undergo a training phase wherein the model may be exposed to the set of training data, such as through iterative processes of learning in which the model adjusts and optimizes its parameters and algorithms to improve its performance on the designated task or series of tasks. This training phase may configure the model to develop the capability to perform its intended function with a high degree of accuracy and efficiency. In embodiments, the conditioning of the set of data may include modification, transformation, and/or the application of targeted algorithms to prepare the data for training. The conditioning step may be configured to ensure that the set of data is in an optimal state for training the model, resulting in an enhancement of the effectiveness of the model's learning process. These features and techniques not only qualify as patent-eligible features but also introduce substantial improvements to the field of computational modeling. These features are not merely theoretical but represent an integration of a concepts into a practical application that significantly enhance the functionality, reliability, and efficiency of the models developed through these processes.

In embodiments, the present disclosure includes techniques for generating a notification of an event that includes generating an alert that includes information specifying the location of a source of data associated with the event, formatting the alert into data structured according to an information format, and/or transmitting the formatted alert over a network to a device associated with a receiver based upon a destination address and a transmission schedule. In embodiments, receiving the alert enables a connection from the device associated with the receiver to the data source over the network when the device is connected to the source to retrieve the data associated with the event and causes a viewer application (e.g., a graphical user interface (GUI)) to be activated to display the data associated with the event. These features represent patent eligible features, as these features amount to significantly more than an abstract idea. These features, when considered as an ordered combination, amount to significantly more than simply organizing and comparing data. The features address the Internet-centric challenge of alerting a receiver with time sensitive information. This is addressed by transmitting the alert over a network to activate the viewer application, which enables the connection of the device of the receiver to the source over the network to retrieve the data associated with the event. These are meaningful limitations that add more than generally linking the use of an abstract idea (e.g., the general concept of organizing and comparing data) to the Internet, because they solve an Internet-centric problem with a solution that is necessarily rooted in computer technology. These features, when taken as an ordered combination, provide unconventional steps that confine the abstract idea to a particular useful application. Therefore, these features represent patent eligible subject matter.

In embodiments, one or more operations and/or functionality of components described herein can be distributed across a plurality of computing systems (e.g., personal computers (PCs), user devices, servers, processors, etc.), such as by implementing the operations over a plurality of computing systems. This distribution can be configured to facilitate the optimal load balancing of traffic (e.g., requests, responses, notifications, etc.), which can encompass a wide spectrum of network traffic or data transactions. By leveraging a distributed operational framework, a system implemented in accordance with embodiments of the present disclosure can effectively manage and mitigate potential bottlenecks, ensuring equitable processing distribution and preventing any single device from shouldering an excessive burden. This load balancing approach significantly enhances the overall responsiveness and efficiency of the network, markedly reducing the risk of system overload and ensuring continuous operational uptime. The technical advantages of this distributed load balancing can extend beyond mere efficiency improvements. It introduces a higher degree of fault tolerance within the network, where the failure of a single component does not precipitate a systemic collapse, markedly enhancing system reliability. Additionally, this distributed configuration promotes a dynamic scalability feature, enabling the system to adapt to varying levels of demand without necessitating substantial infrastructural modifications. The integration of advanced algorithmic strategies for traffic distribution and resource allocation can further refine the load balancing process, ensuring that computational resources are utilized with optimal efficiency and that data flow is maintained at an optimal pace, regardless of the volume or complexity of the requests being processed. Moreover, the practical application of these disclosed features represents a significant technical improvement over traditional centralized systems. Through the integration of the disclosed technology into existing networks, entities can achieve a superior level of service quality, with minimized latency, increased throughput, and enhanced data integrity. The distributed approach of embodiments can not only bolster the operational capacity of computing networks but can also offer a robust framework for the development of future technologies, underscoring its value as a foundational advancement in the field of network computing.

To aid in the load balancing, the computing system of embodiments of the present disclosure can spawn multiple processes and threads to process data traffic concurrently. The speed and efficiency of the computing system can be greatly improved by instantiating more than one process or thread to implement the claimed functionality. However, one skilled in the art of programming will appreciate that use of a single process or thread can also be utilized and is within the scope of the present disclosure.

It is an object of the disclosure to provide a method of generating an enhanced ETA with a dynamic time window for last-mile delivery. It is a further object of the disclosure to provide a system for generating an enhanced ETA with a dynamic time window for last-mile delivery, and a computer-based tool for generating an enhanced ETA with a dynamic time window for last-mile delivery. These and other objects are provided by the present disclosure, including at least the following embodiments.

In one particular embodiment, a method by a computing system for generating an enhanced ETA with a dynamic time window for last-mile delivery is provided. The method includes receiving, by an enhanced ETA system, one or more data signals, standardizing, by a data ingestion and standardization manager, the received data signals into a format compatible with an enhanced ETA model, and processing, by the enhanced ETA model, the standardized data signals to generate an enhanced ETA. In embodiments, the enhanced ETA model includes a station dwell time model configured to predict a dwell time of a train within a station, and a train travel time model configured to predict an expected travel time for the train from a source to a destination. The method also includes generating, by the enhanced ETA model, a dynamic time window for the enhanced ETA based on the dwell time of the train and the expected travel time for the train. In embodiments, the dynamic time window becomes smaller as the train approaches the destination. The method further includes sending, by an asset control manager, a control signal generated based on the enhanced ETA and the dynamic time window to a physical asset, wherein the control signal is configured to actuate movement of the physical asset.

In another embodiment, a system for generating an enhanced ETA with a dynamic time window for last-mile delivery is provided. The system comprises at least one processor and a memory operably coupled to the at least one processor and storing processor-readable code that, when executed by the at least one processor, is configured to perform operations. The operations include receiving, by an enhanced ETA system, one or more data signals, standardizing, by a data ingestion and standardization manager, the received data signals into a format compatible with an enhanced ETA model, and processing, by the enhanced ETA model, the standardized data signals to generate an enhanced ETA. In embodiments, the enhanced ETA model includes a station dwell time model configured to predict a dwell time of a train within a station, and a train travel time model configured to predict an expected travel time for the train from a source to a destination. The operations also include generating, by the enhanced ETA model, a dynamic time window for the enhanced ETA based on the dwell time of the train and the expected travel time for the train. In embodiments, the dynamic time window becomes smaller as the train approaches the destination. The operations further include sending, by an asset control manager, a control signal generated based on the enhanced ETA and the dynamic time window to a physical asset, wherein the control signal is configured to actuate movement of the physical asset.

In yet another embodiment, a computer-based tool for generating an enhanced ETA with a dynamic time window for last-mile delivery is provided. The computer-based tool includes non-transitory computer readable media having stored thereon computer code which, when executed by a processor, causes a computing device to perform operations. The operations include receiving, by an enhanced ETA system, one or more data signals, standardizing, by a data ingestion and standardization manager, the received data signals into a format compatible with an enhanced ETA model, and processing, by the enhanced ETA model, the standardized data signals to generate an enhanced ETA. In embodiments, the enhanced ETA model includes a station dwell time model configured to predict a dwell time of a train within a station, and a train travel time model configured to predict an expected travel time for the train from a source to a destination. The operations also include generating, by the enhanced ETA model, a dynamic time window for the enhanced ETA based on the dwell time of the train and the expected travel time for the train. In embodiments, the dynamic time window becomes smaller as the train approaches the destination. The operations further include sending, by an asset control manager, a control signal generated based on the enhanced ETA and the dynamic time window to a physical asset, wherein the control signal is configured to actuate movement of the physical asset.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 is a block diagram of an exemplary system 100 configured with capabilities and functionality for generating an enhanced ETA that includes a dynamic time window for a last-mile delivery ETA in accordance with embodiments of the present disclosure.

FIG. 2 is a block diagram illustrating an example of the enhanced ETA system 150 configured with capabilities and functionality for generating an enhanced ETA that includes a dynamic time window for a last-mile delivery ETA in accordance with embodiments of the present disclosure.

FIGS. 3A-3F illustrate various examples of standardized model structures for ingestion by a enhanced ETA model to generate an enhanced ETA in accordance with embodiments of the present disclosure.

FIG. 4 shows a high-level flow diagram of operation of a system configured for providing functionality for analyzing track geometry data for track monitoring and defect detection in accordance with embodiments of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

The disclosure presented in the following written description and the various features and advantageous details thereof, are explained more fully with reference to the non-limiting examples included in the accompanying drawings and as detailed in the description. Descriptions of well-known components have been omitted to not unnecessarily obscure the principal features described herein. The examples used in the following description are intended to facilitate an understanding of the ways in which the disclosure can be implemented and practiced. A person of ordinary skill in the art would read this disclosure to mean that any suitable combination of the functionality or exemplary embodiments below could be combined to achieve the subject matter claimed. The disclosure includes either a representative number of species falling within the scope of the genus or structural features common to the members of the genus so that one of ordinary skill in the art can recognize the members of the genus. Accordingly, these examples should not be construed as limiting the scope of the claims.

A person of ordinary skill in the art would understand that any system claims presented herein encompass all of the elements and limitations disclosed therein, and as such, require that each system claim be viewed as a whole. Any reasonably foreseeable items functionally related to the claims are also relevant. The Examiner, after having obtained a thorough understanding of the disclosure and claims of the present application has searched the prior art as disclosed in patents and other published documents, i.e., nonpatent literature. Therefore, the issuance of this patent is evidence that: the elements and limitations presented in the claims are enabled by the specification and drawings, the issued claims are directed toward patent-eligible subject matter, and the prior art fails to disclose or teach the claims as a whole, such that the issued claims of this patent are patentable under the applicable laws and rules of this country.

Various embodiments of the present disclosure are directed to systems and techniques that provide functionality for generating generate an enhanced estimated time of arrival (ETA) that includes a dynamic time window for a last-mile delivery ETA. In particular embodiments, an enhanced ETA system may operate by ingesting and processing various data signals, including historical data, projected traffic information, real-time data, etc. The enhanced ETA system may utilize advanced modeling techniques, incorporating artificial intelligence and machine learning algorithms, to analyze complex patterns and relationships in the data. This functionality may enable the system to generate a dynamic time window for arrival estimates, which may adapt and narrow as the train approaches its destination. By leveraging diverse data sources and enhanced modeling, the system may provide increasingly accurate predictions throughout the journey, potentially improving resource allocation, operational efficiency, and overall supply chain integration in rail transportation and last-mile delivery operations.

It is noted that although the present disclosure focuses on last mile delivery ETAs, the techniques disclosed herein may have applications beyond rail last mile applications, which may operate to provide the technical benefits of the present disclosure to other areas of logistics and customer service. For example, the system of embodiments may be used in intermodal estimated time of notification (ETN) processes. By leveraging the more accurate predictions generated by the enhanced ETA model of embodiments, the ETN system may be able to provide customers with more precise notifications regarding the arrival of their freight. This improved accuracy may enable better planning and coordination for customers awaiting their shipments. Furthermore, the enhanced ETA system of embodiments may contribute to making intermodal transport more accessible to customers for delivery purposes. With more reliable arrival time predictions, customers may be better able to arrange for timely pickup or reception of their goods, which may potentially streamline the entire intermodal transportation process.

In some cases, the enhanced ETA of embodiments may also be applied to improve communication regarding empty car arrivals. The more accurate or tighter ETA window provided by the system of embodiments may allow operators to make more informed decisions about car acceptance or refusal. For example, with a more precise ETA, an operator may be able to refuse a car with a longer lead time, rather than waiting until the train actually arrives at the station. This proactive functionality may enhance operational efficiency and resource management at rail stations. The ability to make decisions with a longer lead time may offer several potential technical benefits. For example, such functionality may allow for better allocation of station resources, reduce congestion, and provide more flexibility in managing incoming traffic. Additionally, this increased decision-making window may help operators to better coordinate with customers and other stakeholders, which may improve overall service quality and customer satisfaction.

In some embodiments, the enhanced ETA system of embodiments may be integrated with other logistics management systems to provide a more comprehensive view of the entire supply chain. This integration may allow for better coordination between different modes of transportation, which may lead to more efficient and reliable end-to-end delivery processes.

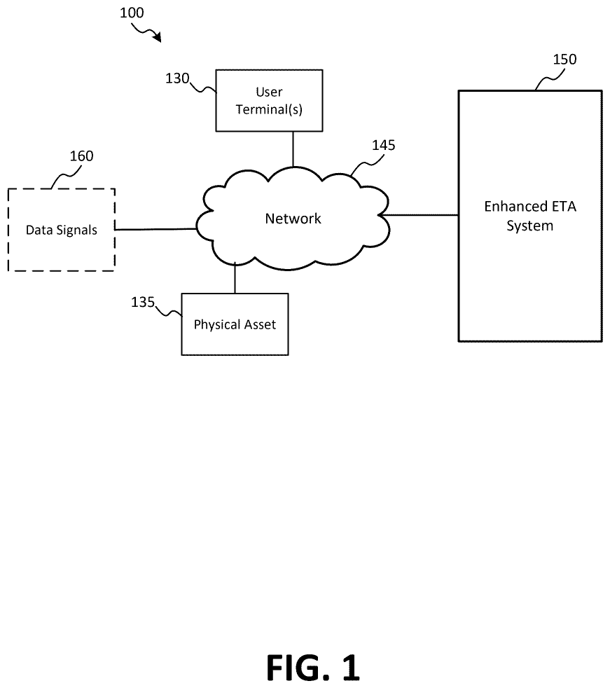

FIG. 1 is a block diagram of an exemplary system 100 configured with capabilities and functionality for generating an enhanced ETA that includes a dynamic time window for a last-mile delivery ETA in accordance with embodiments of the present disclosure. As shown in FIG. 1, system 100 may include user terminal 130, physical asset 135, data signals 160, network 145, and enhanced ETA system 150. These components, and their individual components, may cooperatively operate to provide functionality in accordance with the discussion herein.

It is noted that the functional blocks, and components thereof, of system 100 of embodiments of the present disclosure may be implemented using processors, electronics devices, hardware devices, electronics components, logical circuits, memories, software codes, firmware codes, etc., or any combination thereof. For example, one or more functional blocks, or some portion thereof, may be implemented as discrete gate or transistor logic, discrete hardware components, or combinations thereof configured to provide logic for performing the functions described herein. Additionally, or alternatively, when implemented in software, one or more of the functional blocks, or some portion thereof, may comprise code segments operable upon a processor to provide logic for performing the functions described herein.

It is also noted that various components of system 100 are illustrated as single and separate components. However, it will be appreciated that each of the various illustrated components may be implemented as a single component (e.g., a single application, server module, etc.), may be functional components of a single component, or the functionality of these various components may be distributed over multiple devices/components. In such embodiments, the functionality of each respective component may be aggregated from the functionality of multiple modules residing in a single, or in multiple devices.

It is further noted that functionalities described with reference to each of the different functional blocks of system 100 described herein is provided for purposes of illustration, rather than by way of limitation and that functionalities described as being provided by different functional blocks may be combined into a single component or may be provided via computing resources disposed in a cloud-based environment accessible over a network, such as one of network 145.

The enhanced ETA system 150 is configured to generate an enhanced ETA that includes a dynamic time window for last-mile delivery in rail transportation. The enhanced ETA system 150 may implement an advanced enhanced ETA model, which may incorporate artificial intelligence, machine learning, and/or optimization techniques to process and analyze various data inputs. The enhanced ETA model may ingest data provided by disparate data signals 160, which may include historical data, projected traffic information, and real-time updates. By leveraging these diverse data sources, the enhanced ETA system 150 may generate a dynamic time window for the enhanced ETA, providing a more accurate and flexible prediction of ETAs.

The enhanced ETA system 150 represents a significant improvement over traditional static ETA systems. For example, the enhanced ETA system 150 may provide a dynamic time window for the ETA that represents a significant enhancement over traditional ETA estimates. Unlike conventional systems that typically offer a single static timestamp, the enhanced ETA system 150 generates and includes, in the dynamic time window, a time range within which the train is expected to arrive at the destination. This dynamic time window may provide more comprehensive and actionable information to operators and customers throughout the supply chain.

The dynamic time window generated by the enhanced ETA system 150 may provide several advantages. For example, the dynamic time window in the enhanced ETA may account for potential variability in transit times, allowing for a more realistic representation of arrival possibilities. This functionality may enable better resource planning and risk management for both operators and customers. Additionally, the time window may be continuously updated based on real-time data, providing increasingly accurate estimates as the train approaches its destination.

In embodiments, the size of the dynamic time window may vary according to the proximity to the actual ETA, and may become narrower or smaller as the train nears its destination. For example, several days before the expected train arrival at the destination, the enhanced ETA system 150 may provide an enhanced ETA with a larger or broader time window, such as a 12-hour time window. As the train progresses on its journey, the enhanced ETA system 150 may refine the enhanced ETA, and may narrow the time window to a 4-hour time window within 24 hours before arrival, in some embodiments, and may even further reduce the time windows to a 2-hour range in the final stages of the journey in some embodiments.

By including an array of relevant data points and utilizing enhanced modeling techniques, the enhanced ETA system 150 may be configured to adapt to changing conditions and provide more reliable ETA estimates. This dynamic functionality may allow for continuous refinement of the ETA as new information becomes available, potentially improving resource allocation, customer satisfaction, overall supply chain efficiency, etc. The detailed functionality and components of the enhanced ETA system 150, including the specific data processing techniques and model implementations, will be described in greater detail in the following sections of the present disclosure.

The user terminal 130 may include a mobile device, a smartphone, a tablet computing device, a personal computing device, a laptop computing device, a desktop computing device, a computer system of a vehicle, a personal digital assistant (PDA), a smart watch, another type of wired and/or wireless computing device, or any part thereof. In embodiments, the user terminal 130 may provide a user interface that may be configured to provide an interface (e.g., a graphical user interface (GUI)) structured to facilitate an operator interacting with system 100, e.g., via network 145, to execute and leverage the features provided by enhanced ETA system 150. In embodiments, the operator may be enabled, e.g., through the functionality of the user terminal 130, to input data related to trains, stations, and/or related to the data in data signals 160 that may be used by system 100 to generate the enhanced ETA. The user terminal 130 may also be configured to receive and display the enhanced ETA once generated by the enhanced ETA system 150. In some embodiments, the user terminal 130 may be used to send a control signal to the physical asset 135, which may cause the physical asset 135 to be actuated and relocate from one location to another. For example, the control signal may instruct the physical asset 135 to move to a specific location based on the enhanced ETA. In embodiments, the user terminal 130 may be configured to communicate with other components of system 100, such as via network 145, facilitating the exchange of information and control signals throughout the system.

In embodiments, network 145 may facilitate communications between the various components of system 100 (e.g., hub 140, DSRO system 160, and/or user terminal 130). Network 145 may include a wired network, a wireless communication network, a cellular network, a cable transmission system, a Local Area Network (LAN), a Wireless LAN (WLAN), a Metropolitan Area Network (MAN), a Wide Area Network (WAN), the Internet, the Public Switched Telephone Network (PSTN), etc.

The physical asset 135 may represent a variety of railroad network assets that can be mobilized or relocated in response to the enhanced ETA generated by the enhanced ETA system 150. These physical assets may include, but are not limited to, locomotives, hostlers, trucks, cranes, loading equipment, and/or any other movable equipment used in rail transportation operations. In some embodiments, the physical asset 135 may be capable of receiving and responding to control signals generated (in some embodiments automatically by system 100) based on the enhanced ETA. In some embodiments, these control signals may be used to automatically actuate the physical asset 135, causing the physical asset 135 to move from one location to another. For example, an automatic control signal may instruct a hostler to relocate to a specific track in anticipation of an incoming train, based on the dynamic time window provided by the enhanced ETA. Alternatively, the control signals may be used to guide manual operation of the physical asset 135, with operators using the information to make informed decisions about asset positioning and relocation.

The data signals 160 may be configured to carry a diverse and varied array of information from various sources that the enhanced ETA system 150 can utilize to generate dynamic ETA predictions. These data signals 160 may include a range of data types, including but not limited to train events, train schedules, train consist information, train lineup information, real-time location data, historical performance metrics, weather conditions, infrastructure status updates, etc. The enhanced ETA system 150 may be configured to ingest and process these varied data signals, and to extract and use relevant information to generate the enhanced ETA.

In some embodiments, the data in the data signals 160 may be obtained from multiple sources within the train network itself. For example, the data signals 160 may be obtained from internal databases maintained by the railway operator, which may store historical performance data, maintenance schedules, and/or current operational status of various assets. In some embodiments, the data in the data signals 160 may be sourced from onboard systems of trains, such as GPS trackers or other telemetry devices, providing real-time location and speed data.

In embodiments, the data in the data signals 160 may be obtained from external sources and systems. These may include weather forecasting services, providing data on current and predicted weather conditions that may impact train travel times. Traffic management systems for both rail and road networks may contribute data on congestion levels and potential delays. In some embodiments, the data signals 160 may incorporate information from social media feeds or news outlets, which may provide early indicators of events that might affect train schedules.

In embodiments, the enhanced ETA system 150 may be configured to continuously and/or periodically receive and process the data in the data signals 160, which may enable for real-time or near real-time updates and refinements to the enhanced ETA predictions.

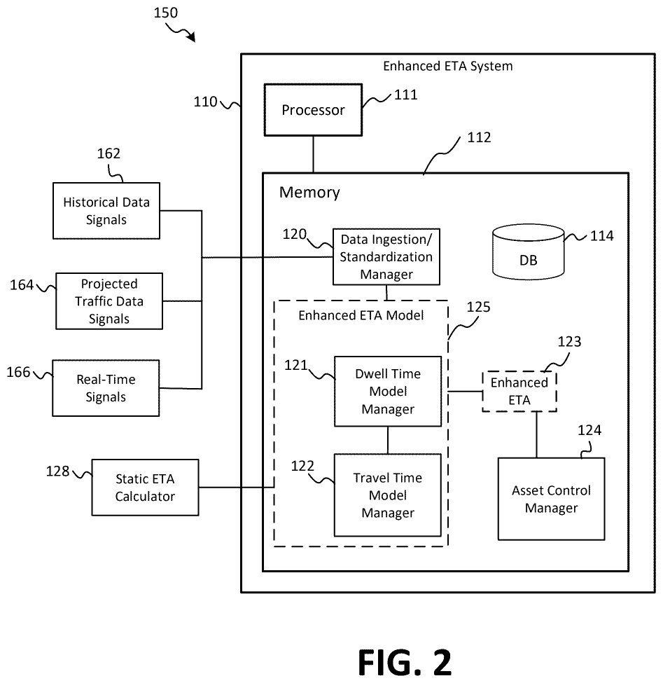

FIG. 2 is a block diagram illustrating an example of the enhanced ETA system 150 configured with capabilities and functionality for generating an enhanced ETA that includes a dynamic time window for a last-mile delivery ETA in accordance with embodiments of the present disclosure. As shown in FIG. 2, the enhanced ETA system 150 may be implemented in a server (e.g., server 110). In embodiments, functionality of server 110 to facilitate operations of the enhanced ETA system 150 may be provided by the cooperative operation of the various components of server 110, as will be described in more detail below.

It is noted that although FIG. 2 shows server 110 as a single server, it will be appreciated that server 110 (and the individual functional blocks of server 110) may be implemented as separate devices and/or may be distributed over multiple devices having their own processing resources, whose aggregate functionality may be configured to perform operations in accordance with the present disclosure. Furthermore, those of skill in the art would recognize that although FIG. 2 illustrates components of server 110 as single and separate blocks, each of the various components of server 110 may be a single component (e.g., a single application, server module, etc.), may be functional components of a same component, or the functionality may be distributed over multiple devices/components. In such embodiments, the functionality of each respective component may be aggregated from the functionality of multiple modules residing in a single, or in multiple devices. In addition, particular functionality described for a particular component of server 110 may actually be part of a different component of server 110, and as such, the description of the particular functionality described for the particular component of server 110 is for illustrative purposes and not limiting in any way.

As shown in FIG. 2, server 110 includes processor 111, memory 112, data ingestion and standardization manager 120, enhanced ETA model 125, asset control manager 124, static ETA calculator 128, and database 114.

Processor 111 may comprise a processor, a microprocessor, a controller, a microcontroller, a plurality of microprocessors, an application-specific integrated circuit (ASIC), an application-specific standard product (ASSP), or any combination thereof, and may be configured to execute instructions to perform operations in accordance with the disclosure herein. In some embodiments, implementations of processor 111 may comprise code segments (e.g., software, firmware, and/or hardware logic) executable in hardware, such as a processor, to perform the tasks and functions described herein. In yet other embodiments, processor 111 may be implemented as a combination of hardware and software. Processor 111 may be communicatively coupled to memory 112.

Memory 112 may comprise one or more semiconductor memory devices, read only memory (ROM) devices, random access memory (RAM) devices, one or more hard disk drives (HDDs), flash memory devices, solid state drives (SSDs), erasable ROM (EROM), compact disk ROM (CD-ROM), optical disks, other devices configured to store data in a persistent or non-persistent state, network memory, cloud memory, local memory, or a combination of different memory devices. Memory 112 may comprise a processor readable medium configured to store one or more instruction sets (e.g., software, firmware, etc.) which, when executed by a processor (e.g., one or more processors of processor 111), perform tasks and functions as described herein.

Memory 112 may also be configured to facilitate storage operations. For example, memory 112 may comprise database 114 for storing various information related to operations of system 100. For example, database 114 may store configuration information related to operations of the enhanced ETA system 150. In embodiments, database 114 may store information related to various models used during operations of the enhanced ETA system 150, such as a enhanced ETA model 125. Database 114 is illustrated as integrated into memory 112, but in some embodiments, database 114 may be provided as a separate storage module or may be provided as a cloud-based storage module. Additionally, or alternatively, database 114 may be a single database, or may be a distributed database implemented over a plurality of database modules.

In embodiments, the functionality of the enhanced ETA system 150 is configured to be dynamic and responsive, and to adapt to changing conditions and new information in real-time. For example, in some embodiments, the enhanced ETA system 150 may ingest and process disparate data signals from various sources. These may include historical data signals, projected traffic signals, and real-time signals, among other types of signals. This diverse range of data inputs may allow the enhanced ETA system 150 to consider both long-term patterns and immediate circumstances when generating predictions. In some embodiments, the enhanced ETA system 150 may implement enhanced ETA model 125 to take into account multiple factors that can affect a train's journey. For example, the enhanced ETA model 125 may consider station dwell time, which represents the duration a train spends at a particular station, as well as travel time to a destination. By including these types of information, the enhanced ETA model 150 may generate enhanced ETA predictions in the enhanced ETA. In embodiments, the enhanced ETA system 150 may use a standardization process for the data ingested, and may convert non-formatted data into a standardized format that can be processed by the enhanced ETA model 125.

The data ingestion and standardization manager 120 may be configured to receive or obtain the data in the data signals 160 and to ensure that the data is in a standardized format that is compatible with the enhanced ETA model 125. In this manner, the data ingestion and standardization manager 120 processes and prepares the disparate array of incoming data in the data signals 160 for analysis and ETA prediction.

In embodiments, the data obtained by the data ingestion and standardization manager 120 may include data in one or more data signals of the data signals 160. The one or more data signals of the data signals 160 may include the historical data signals 162, the projected traffic signals 164, and the real-time signals 166, among other types of signals.

It is important to note that the description herein of three types of data signals (e.g., historical data signals, projected traffic signals, and real-time signals) is provided for illustrative purposes only and should not be construed as limiting in any way. Indeed, in some embodiments, the enhanced ETA system 150 may be configured to ingest and process a wide variety of data signals beyond these three types of signals.

In embodiments, the historical data signals 162 may include a range of historical information related to train operations and station activities. In some embodiments, the historical data signals 162 may include previously measured dwell times for trains, which may be categorized by various attributes such as train ID, train type, or freight type. This historical dwell time data may provide insights into patterns and trends that may influence future dwell time predictions.

In some embodiments, the historical data signals 162 may include records of previous train schedules, which may provide information on planned arrival and departure times, as well as any deviations from these schedules. The historical data signals 162 may also include previous logs detailing actual train arrivals and departures from the station, which may reveal discrepancies between scheduled and actual times.

In embodiments, the historical data signals 162 may include data on historical patterns related to traffic within the station. This may include information on peak periods of activity, common bottlenecks, seasonal variations in station traffic, etc. Similarly, the historical data signals 162 may include historical patterns related to dwell time within the station, which may reveal trends in how long trains spend at the station under various conditions.

In some embodiments, the historical data signals 162 may include other types of relevant historical information that may impact train operations and dwell times. This may include data on past weather conditions, previous maintenance schedules, historical records of exceptional events that affected station operations, etc.

The projected traffic signals 164 may include data related to scheduled events at the station that are relevant to train operations and ETA calculations. In some embodiments, the signals projected traffic signals 164 may include scheduled train arrival and departure events for the train station. For example, train event data within the projected traffic signals 164 may include indications of train arrivals at a station, such as a train ID, as well as a date and time of the expected train arrivals. In addition to arrival information, the train event data in the projected traffic signals 164 may also contain data about scheduled departure times for trains.

In embodiments, the data in the projected traffic signals 164 may include data related to scheduled inspections, such as inspection length which may indicate the length of time for inspecting a train within the station before the train can be released for departure. This inspection length information may be useful for estimating the overall dwell time of a train at a station. In some embodiments, the inspection data in the projected traffic signals 164 may include details about the type of inspection scheduled for each train. For example, different types of inspections may require different amounts of time and resources, which may impact the train's departure time from the station. For example, a routine safety check may take less time than a significant mechanical inspection.

In some embodiments, the inspection data in the projected traffic signals 164 may include information about the availability and scheduling of inspection personnel. This data may include the number of inspectors on duty during different shifts and their specializations, and any planned absences or training sessions that may affect inspection capacity. By ingesting this information, the enhanced ETA system 150 may be able to more accurately predict potential bottlenecks or delays in the inspection process. In some embodiments, the inspection data in the projected traffic signals 164 may include information on the availability and status of inspection equipment and facilities. This may include data on scheduled maintenance of inspection tools, the capacity of inspection areas within the station, any planned upgrades, and/or any changes to inspection procedures that may affect processing times.

In some embodiments, the inspection data in the projected traffic signals 164 may include data on the expected condition of incoming trains based on their journey and previous inspection records. This information may help the enhanced ETA system 150 predict whether a train is likely to require additional inspection time due to potential issues identified during the train's journey. In some embodiments, the inspection data in the projected traffic signals 164 may include data related to any special inspection requirements for specific types of freight carried by a train and/or during certain weather conditions. For example, trains carrying hazardous materials may require more thorough inspections, and extreme weather conditions may require additional safety checks.

In embodiments, another type of data that may be included in the projected traffic signals 164 may include congestion data. The congestion data may include data related to the current and/or anticipated congestion levels within the station. The congestion data may include various metrics that may affect train dwell times and overall station efficiency. For example, the congestion data may indicate the number of trains currently present in the station, which may directly impact the duration a newly arriving train or an already present train may need to remain in the station.

In some embodiments, the congestion data may include data on the types of trains currently or expected in the station, categorized by factors such as length, cargo type, or priority level. This information may be relevant to determining how quickly the station can process incoming trains and how long newly arrived trains may need to wait before being serviced. For example, freight trains carrying hazardous materials or oversized loads may require additional processing time compared to standard passenger trains.

In this manner, the congestion data may provide a view into the station's capacity utilization. This may include information on the number of occupied tracks, the current queue of trains waiting to enter the station, and any bottlenecks in specific areas of the station such as loading docks or maintenance facilities.

In some embodiments, the congestion data may also include predictive elements, forecasting expected congestion levels based on scheduled arrivals and departures. For example, the congestion data may include forecasts of expected congestion levels at different times of the day or week. These predictions may be based on historical patterns, scheduled arrivals and departures, and any known factors that could affect station capacity, such as planned maintenance or special events.

The projected traffic signals 164 may also include data on the station's strategies for managing congestion. The station's strategies for managing congestion may include data on planned rerouting of trains, temporary storage of cars on auxiliary tracks, and/or the activation of overflow facilities during peak periods. By including data on the station's strategies for managing congestion into the calculations, the enhanced ETA system 150 may provide more accurate predictions of how congestion may affect individual trains' dwell times. In some embodiments, the congestion data may also include data on external factors that may be relevant to the congestion levels within the station. This data may include information on traffic conditions on connecting road networks, which may affect the rate at which freight may be transferred from trains to trucks, or data on weather conditions that might slow down station operations.

In embodiments, the projected traffic signals 164 may include information about the train consist for which the ETA is being estimated. The consist data may include data on the number of locomotives scheduled to be picked up or set out at the station for the train consist. This information may be relevant as the addition or removal of locomotives may impact the train's overall length, weight, and power, and may affect the train's processing time within the station and its travel speed once the train departs the station.

In some embodiments, the consist data in the projected traffic signals 164 may include data on the number of cars in each set out group. This information may be used to estimate the time required for switching operations within the station, for example, as larger setout groups may require more time to process and may extend the train's dwell time at the station.

In some embodiments, the consist data may include information on the types of cars in the train consist. For example, the consist data signals may indicate whether the train includes specialized cars such as refrigerated units, tank cars, oversized load carriers, etc. This information may be relevant as different car types may require specific handling procedures or additional inspections, which may be used to determine the train's processing time at the station.

In some embodiments, the consist data may include data on the total length and weight of the train consist. This information may be used to determine which tracks within the station can accommodate the train and how quickly the train can be processed. Longer or heavier trains may require more time for braking and acceleration, which may affect both station operations and travel times.

In some embodiments, the consist data may include information about the freight being carried by the train. This freight data may include details about the types of goods, priority levels, and/or any special handling requirements. This information may be used by the enhanced ETA model 125 to predict potential delays related to freight processing or prioritizing certain trains over others in congested situations. In some embodiments, the consist data may include data on any planned changes to the train consist during the train's journey. This may include information about scheduled pickup or setout operations at intermediate stations, which may affect the train's length, weight, and travel time as the train progresses towards the final destination.

The real-time signals 166 may include data related to real-time activities at the station. In some embodiments, the real-time signals 166 may provide up-to-the-minute information about train movements and station operations, allowing the enhanced ETA system 150 to make dynamic adjustments to its predictions. For example, the real-time event data in the real-time signals 166 may include train arrival events, which may include information on a date and time at which a train arrives at the station. This information may be used, for example by the station dwell time model (e.g., as implemented by the dwell time model manager 121) of the enhanced ETA model 125 to estimate how long the train may remain within the station. In addition, by comparing the actual arrival time to the scheduled arrival time, the enhanced ETA model 125 may be able to account for any delays or early arrivals that may impact subsequent operations.

In some embodiments, the real-time event data in the real-time signals 166 may include train departure events, which may include information on the exact date and time at which a train departs the station. This information may be used, for example by the train travel time model (e.g., as implemented by the travel time model manager 122) of the enhanced ETA model 125 to estimate how long the train may take to travel to its destination. In addition, by analyzing the actual departure time in relation to the scheduled departure time, the enhanced ETA model 125 may be able to adjust its travel time predictions to account for any delays or changes in the train's schedule.

In some embodiments, the real-time signals 166 may include data on ongoing maintenance activities within the station. This maintenance data may be used by enhanced ETA model 125 to estimate the dwell time of trains affected by these maintenance events. For example, the real-time signals 166 may provide real-time updates on the progress of maintenance work, including any unexpected complications or delays that may extend the originally estimated completion time.

The maintenance data in the real-time signals 166 may include information about the current availability and location of maintenance crews within the station. In embodiments, the maintenance data may be used to estimate response times for addressing maintenance needs that may arise during operations, which may allow for more accurate predictions of how quickly issues can be resolved and trains can be cleared for departure.

In some embodiments, the maintenance data in the real-time signals 166 may include updates on the inventory levels of commonly needed spare parts or materials used in maintenance operations. This information may be used by the enhanced ETA model 125 to predict whether a maintenance event is likely to be prolonged due to parts shortages, or if the maintenance event can be resolved quickly due to readily available resources.

In some embodiments, the maintenance data in the real-time signals 166 may include data on emergency maintenance situations that may arise. These emergency maintenance events may significantly impact station operations and train schedules. In some embodiments, the maintenance data in the real-time signals 166 may include information on the current status of maintenance equipment within the station. This may include data on which pieces of equipment are currently in use and which are available, and which pieces of equipment are undergoing maintenance or repairs. This information may be used by the enhanced ETA model 125 to estimate how quickly maintenance tasks can be completed, which may affect the dwell time of trains requiring maintenance.

In some embodiments, the maintenance data in the real-time signals 166 may include data on temporary restrictions or changes in station operations due to ongoing maintenance work. For example, if a particular track or section of the station is closed for maintenance, this may affect the routing and processing of trains within the station. By including this information, the enhanced ETA model 125 may be able to more accurately predict how these temporary changes may impact train dwell times and departure schedules.

In embodiments, the real-time signals 166 may include information related to the train location within the station, as well as the number of trains at each location. The current location of a train inside the station may be a strong indicator of its potential dwell time. For example, a train situated on the mainline track may have a relatively short estimated departure time (e.g., within 1-2 hours), while a train positioned on a yard track may have a longer estimated departure time (e.g., may not depart for at least 5 hours). As such, the specific location of a train within the station may be closely associated with its expected dwell time. This real-time location data may allow the enhanced ETA model 125 to refine its dwell time predictions and adjust overall ETA calculations accordingly.

In some embodiments, the location data in the real-time signals 166 may include data on the current status of each train within the station. For example, the location data may include information on whether the train is currently undergoing inspection, loading or unloading operations, maintenance, is ready for departure, etc. In some embodiments, the location data in the real-time signals 166 may include data on the movement of individual cars within the station, which may be particularly relevant for freight operations where cars may be added to or removed from trains. This may allow the enhanced ETA model 125 to predict the time required for train assembly or disassembly operations, which may enhance the overall dwell time estimates.

In some embodiments, the location data in the real-time signals 166 may include continuous updates on the movement of trains within the station. This may include information on when a train moves from one track to another, enters or exits specific areas of the station such as maintenance facilities or loading docks, or changes its status (e.g., from “waiting” to “being serviced”), etc. The enhanced ETA model 125 may use this updated information to refine the dwell time predictions as the train progresses through different stages within the station.

In some embodiments, the location data in the real-time signals 166 may include data on the current occupancy status of various station facilities. For example, the location data may include information on which tracks are currently occupied, which loading docks are in use, which maintenance bays are available, etc. This occupancy data, especially when combined with the train location information, may be used by the enhanced ETA model 125 to more accurately predict potential bottlenecks or delays that may affect a train's dwell time.

In some embodiments, the real-time signals 166 may incorporate data from GPS or other positioning systems installed on trains. This may provide accurate, real-time location data not just within the station, but also as the train approaches or departs from the station. The enhanced ETA model 125 may use this information to predict dwell times more precisely, as well as tracking a train's travel once it has departed the station.

It is noted that, in embodiments, configuring certain data to be included in real-time data signals may provide the advantage of maintaining data freshness and validity. This functionality may be particularly beneficial for time-sensitive information that can quickly become outdated. For example, data related to a train's current location may rapidly lose its accuracy if not provided in real-time. A delay in transmitting this information may result in the train having moved from its previously reported position, potentially rendering the location data inaccurate and less useful for precise ETA calculations.

In some embodiments, the data in the real-time signals 166 may include data on weather conditions that may be relevant to train operations. This data may include information on current precipitation, wind speeds, visibility, and temperature at various points along the train's route. The enhanced ETA model 125 may use this information to anticipate and account for weather-related delays or safety concerns that may affect travel times or station operations.

In some embodiments, the data in the real-time signals 166 may include up-to-the-minute information on track conditions. This may include data on any sudden obstructions, such as fallen trees or debris on the tracks, as well as information on track maintenance activities that may be occurring along the route. The enhanced ETA model 125 may use this information to adjust predictions to account for potential delays or rerouting caused by these conditions.

In some embodiments, the data in the real-time signals 166 may include data on the current status of critical train systems. This may encompass information on engine performance, brake system status, mechanical issues, etc., that may arise during the train's journey. The enhanced ETA model 125 may use this information to anticipate potential delays due to mechanical problems or required maintenance stops.

In some embodiments, the data in the real-time signals 166 may include information on crew changes or availability. This may include data on the current location of relief crews, any delays in crew arrivals, or unexpected crew shortages. The enhanced ETA model 125 may use this information to predict potential delays related to crew logistics. In some embodiments, the data in the real-time signals 166 may include data on current traffic conditions on connecting road networks. which may affect the transfer of freight between trains and trucks.

In some embodiments, the data in the real-time signals 166 may include information on the current status of loading and unloading equipment at the current station, as well as intermediate stations along the train's route to the final destination. This may include data on the availability of hostlers, trucks, cranes, forklifts, and/or other machinery for freight handling. The enhanced ETA model 125 may use this information to anticipate potential bottlenecks in loading or unloading operations that may affect a train's dwell time at a particular station.

In some embodiments, the data ingestion and standardization manager 120 may be configured to handle a variety of data formats and sources. The data ingestion and standardization manager 120 may be configured to ingest structured data, such as database records and spreadsheets, as well as unstructured data, such as text from internal communications of the rail station operators, and/or social media feeds and news articles. The data ingestion and standardization manager 120 may use various data parsing and extraction techniques to identify relevant information from these diverse sources.

In embodiments, the standardization functionality of the data ingestion and standardization manager 120 may include several processes. For example, the data ingestion and standardization manager 120 may convert all incoming data into a consistent format, ensuring that data fields are uniformly named and structured across different sources. This standardization process may also include data cleaning operations, such as removing duplicates, correcting errors, identifying and filling in missing values where possible, reconciling entries, etc.

In some embodiments, the data ingestion and standardization manager 120 may include machine learning (ML) algorithms and/or artificial intelligence (AI) models for data processing. These algorithms may learn to recognize patterns in the incoming data, allowing for more efficient extraction of relevant information and more accurate standardization of data formats. In some embodiments, the data ingestion and standardization manager 120 may be configured for data validation, which may ensure that the ingested and standardized data meets certain quality criteria before being passed on to the enhanced ETA model 125. This may include checks for data completeness, consistency, and accuracy, with flags raised for any data that fails to meet the established standards.

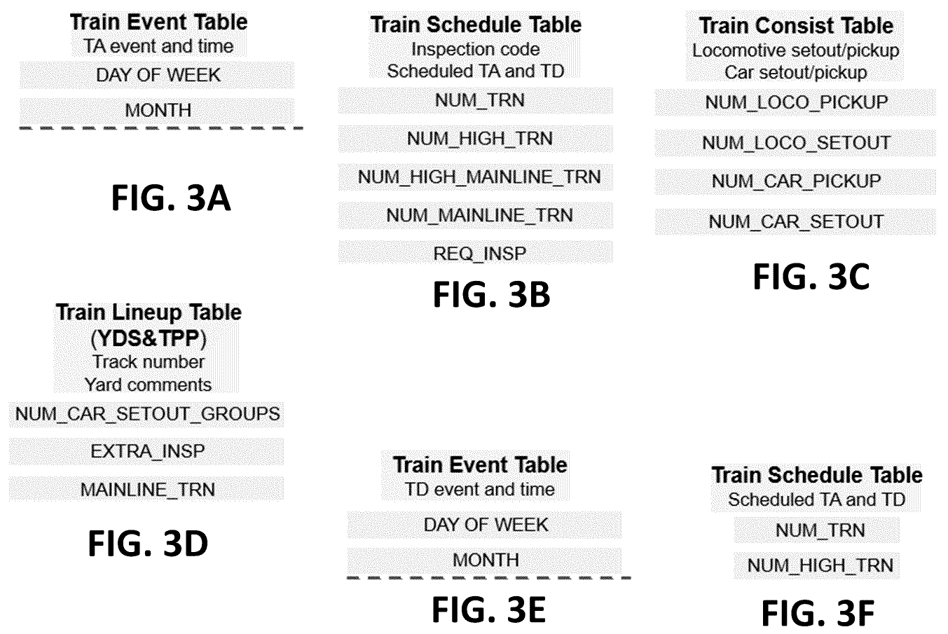

In embodiments, the functionality of the data ingestion and standardization manager 120 to standardize incoming data into a consistent format may include defining standardized model structures with specific formats designed to standardize the data ingested by the enhanced ETA model 125. For example, the standardized model structures may include a train event table structure that may be implemented to organize information related to train arrivals and expected station times. The standardized format of this train event table structure, as illustrated in FIG. 3A, may allow for consistent data representation across various inputs. When generating the enhanced ETA, the enhanced ETA model 125 may be configured to ingest and interpret data from the standardized train event table structure, enabling more accurate and reliable predictions. In some embodiments, the train event table structure may include fields for the train arrival (TA) event, the time of the event, the day of the week, and the month. This standardized format may allow the enhanced ETA model 125 to process and analyze arrival data across multiple trains and stations.

In some embodiments, the standardized model structures may include a train schedule event table structure that may be configured to include information related to scheduled train events, such as arrival time and inspections for the train, as well as the location at which the train may be scheduled to be and/or the real-time location of the train. The format of the train schedule event table structure may be standardized as shown in FIG. 3B. The enhanced ETA model 125 may be configured to ingest the train schedule event table structure when generating the enhanced ETA.

In some embodiments, the train schedule event table structure may include various fields that provide information about scheduled train events. For example, the train schedule event table structure may include an inspection code field that indicates the type of inspection scheduled for a particular train, and fields for scheduled train arrival (TA) and train departure (TD) times. In embodiments, the train schedule event table structure may include fields that provide context about the overall station activity, such as the number of trains (NUM_TRN) expected at the station during a given period, the number of high priority trains (NUM_HIGH_TRN), and the number of high priority mainline trains (NUM_HIGH_MAINLINE_TRN). In embodiments, the train schedule event table structure may include fields for the number of mainline trains (NUM_MAINLINE_TRN), which may provide information about the volume of through traffic at the station, and/or for required inspections (REQ_INSP), including details about mandatory checks that may impact a train's dwell time at the station.

In embodiments, the standardized model structures may include a train consist table structure configured to include information related to the composition of the train consist. The format of the train consist table structure may be standardized as shown in FIG. 3C. The enhanced ETA model 125 may be configured to ingest the train consist table structure when generating the enhanced ETA.

In some embodiments, the train consist table structure may include various fields that provide detailed information about the makeup of the train. For example, the train consist table structure may include fields for locomotive setout and pickup, which may indicate changes to the number of locomotives in the train consist at a given station, and fields for car setout and pickup may be included, which may include information on changes to the number of cars in the train consist.

In some embodiments, the train consist table structure may incorporate specific numeric fields to quantify these changes. This may include fields such as the number of locomotives picked up (NUM_LOCO_PICKUP), the number of locomotives set out (NUM_LOCO_SETOUT), the number of cars picked up (NUM_CAR_PICKUP) and the number of cars set out (NUM_CAR_SETOUT). The enhanced ETA model 125 may use the data in the standardized train consist table structure to account for changes in train composition that could affect travel times and station dwell times. For example, the addition or removal of locomotives may impact the train's speed and acceleration capabilities, while changes in the number of cars may affect the train's overall length and weight. These factors may influence loading and unloading times, as well as the train's performance on different track segments. The train consist information may also be useful to the enhanced ETA model 125 for predicting potential delays or complications at stations. For example, a train with a large number of cars being set out or picked up may require more time for switching operations, potentially affecting its dwell time and subsequent ETA calculations.

In embodiments, the standardized model structures may include a train lineup table structure configured to include information related to the lineup of the train within the station. The format of the train lineup table structure may be standardized as shown in FIG. 3D. The enhanced ETA model 125 may be configured to ingest the train lineup table structure when generating the enhanced ETA.

In some embodiments, the train lineup table structure may include various fields that provide detailed information about the positioning and processing of trains within the station. For example, the train lineup table structure may include a field for track number, which may indicate the specific track on which a train is located or scheduled to arrive, a field for yard comments that may allow for the inclusion of additional contextual information that may impact train processing times or station operations, a field for the number of car setout groups (NUM_CAR_SETOUT_GROUPS), a field for extra inspections (EXTRA_INSP), and a field for mainline trains (MAINLINE_TRN). This distinction may be important for predicting station congestion and prioritizing train movements. Using the train lineup table structure, the enhanced ETA model 125 may incorporate detailed information about the current and planned positioning of trains within the station to predict potential conflicts, estimate processing times, generate more precise ETAs that account for the specific operational context of each train within the station environment more accurately, etc.

In embodiments, the standardized model structures may include a train departure event table structure configured to include information related to train departures and the time at which the train is expected to depart from a station. The format of the train departure event table structure may be standardized as shown in FIG. 3E. The enhanced ETA model 125 may be configured to ingest the train departure event table structure when generating the enhanced ETA.

In some embodiments, the train departure event table structure may include various fields that provide detailed information about train departures from a station. For example, the train departure event table structure may include a field for the train departure event, which may indicate the specific departure event being recorded, and a field for the time of the departure event, which may provide precise timing information, allowing the enhanced ETA model 125 to calculate travel times and predict potential delays or early arrivals at subsequent stations. In some embodiments, the train departure event table structure may include fields for the day of the week and the month of the departure event, which may be used by the enhanced ETA model 125 for identifying patterns in train departures, such as variations in schedules or performance based on different days or seasons. Analyzing these patterns allows the enhanced ETA model 125 to generate more accurate predictions that account for recurring temporal factors. The enhanced ETA model 125 may use data in the standardized train departure event table structure to include detailed information about train departures from various stations along a route, which may enable the enhanced ETA model 125 to calculate travel times between stations, predict potential delays, predict early arrivals, and/or generate more precise ETAs that account for the specific departure patterns and schedules of each train within the network.

In embodiments, the train departure event table structure may complement other data structures, such as the train arrival event table and the train schedule event table, to provide a comprehensive view of train movements throughout the network. By combining departure information with arrival and scheduling data, the enhanced ETA model 125 may be able to generate more accurate predictions of ETAs at final destinations for the enhanced ETA.

In embodiments, the standardized model structures may include a train destination schedule table structure configured to include information related to train arrivals and departures at the destination. The format of the train destination schedule table structure may be standardized as shown in FIG. 3F. The enhanced ETA model 125 may be configured to ingest the train destination schedule table structure when generating the enhanced ETA.

In some embodiments, the train destination schedule table structure may include various fields that provide information about scheduled train events at the final destination. For example, the train destination schedule table structure may contain fields for scheduled train arrival (TA) and train departure (TD) times at the destination, allowing the enhanced ETA model 125 to consider both the expected arrival and departure times when calculating the enhanced ETA. In some embodiments, the train destination schedule table structure may contain fields that include context about the overall destination station activity, such as the number of trains (NUM_TRN) expected at the destination station during a given period and the number of high priority trains (NUM_HIGH_TRN), which may allow the enhanced ETA model 125 to consider destination station congestion and prioritization factors in its calculations.

In embodiments, the train destination schedule table structure may complement other data structures, such as the train event table and the train schedule event table, to provide a more complete picture of train movements throughout the entire journey. By combining destination-specific information with data from intermediate stations, the enhanced ETA model 125 may be able to generate more precise and reliable predictions of train performance and ETAs for the enhanced ETA.

It is noted that in some embodiments, the standardized model structures may include structures representing any combination of the structures described herein. For example, a standardized model structure may represent a combination of the train event table structure and the train schedule event table structure, and/or portions thereof. As such, the specific description of the tables described herein should not be construed as limiting in any way.

In embodiments, the data ingestion and standardization manager 120 may be configured to capture data for the data signals from various sources, including communications between operators of the station. The data ingestion and standardization manager 120 may analyze these communications to identify relevant data that may be included in the data signals and convert this information into the standardized format required by the appropriate model structure.

For example, the data ingestion and standardization manager 120 may intercept and process textual or prose data from internal communications between operators within the station. These communications may include emails, text messages, instant messages, and/or other forms of digital correspondence. The data ingestion and standardization manager 120 may employ natural language processing techniques to extract pertinent information from these communications and convert it into the standardized data format used by the model structures for the enhanced ETA model 125.

In some embodiments, the data ingestion and standardization manager 120 may be configured to identify specific types of information within the communications. For example, if an internal message between two operators indicates an issue with an inspection that needs to be addressed, the data ingestion and standardization manager 120 may recognize this as relevant information for the ETA calculation. The data ingestion and standardization manager 120 may then extract key details such as the nature of the inspection issue, the estimated time to resolve the issue, what resources may be required to resolve the issue, any potential impact on train schedules, etc.

The data ingestion and standardization manager 120 may utilize various algorithms and machine learning and/or AI techniques to improve its ability to identify and extract relevant information from unstructured communication data. These algorithms may be trained to recognize patterns, keywords, and context clues that indicate relevant operational information.

Once the relevant information is extracted, the data ingestion and standardization manager 120 may convert it into the standardized format required by the appropriate model structure. For example, information about an inspection issue may be converted into entries in the train schedule event table structure or the train lineup table structure, depending on the nature of the information and its potential impact on train operations.

In some embodiments, the data ingestion and standardization manager 120 may be configured to handle semi-structured data sources, such as spreadsheets or databases used by operators to track various aspects of station operations. The data ingestion and standardization manager 120 may be configured to parse these data sources and extract relevant information, converting it into the standardized format required by the model structures.

In some embodiments, the data ingestion and standardization manager 120 may operate in real-time, continuously and/or periodically monitoring and processing incoming communications and data sources. This real-time processing functionality may enable the enhanced ETA model 125 to incorporate the most up-to-date information into its calculations.

The enhanced ETA model 125 may be implemented by integrating machine learning (ML) models and/or AI models. This integration may allow the enhanced ETA model 125 to leverage different types of data and techniques to generate more accurate enhanced ETAs. For example, the ML and/or AI models within the enhanced ETA model 125 may be specialized to process and analyze historical data from the historic data signals and projected traffic data from the projected traffic signals. These ML and/or AI models may be trained on large datasets of past train movements, schedules, and traffic patterns to identify trends, correlations, and patterns that can contribute to more accurate ETA predictions. For example, the ML and/or AI models may learn to recognize how certain factors, such as seasonal variations or specific events, have historically affected train arrival times.

Optimization models (which may themselves include AI and/or ML models trained for optimization) may be configured to focus on real-time information provided by the real-time signals. These optimization models may use various optimization techniques to adjust and refine ETA predictions based on current conditions and immediate updates. For example, if a real-time signal indicates an unexpected delay at a particular station, the optimization model may quickly recalculate ETAs for affected trains, taking into account potential ripple effects throughout the network.

In some embodiments, the integration of ML, AI, and/or optimization models may involve combining their outputs to produce a final enhanced ETA. This combination process may be implemented in various ways, depending on the specific requirements and characteristics of the rail network. For example, the system may use a weighted average of the predictions from both types of models, with the weights potentially adjusting based on the reliability or relevance of different data sources at different times. The integrated functionality may allow the enhanced ETA model 125 to benefit from both the long-term insights provided by historical data analysis and the immediate responsiveness to current conditions. This combination may result in ETA predictions that are both grounded in historical patterns and adaptive to real-time changes in the rail network.

In some cases, the enhanced ETA model 125 may use feedback loops between the ML and/or AI models and the optimization components. For example, the results of real-time optimizations may be fed back into the ML and/or AI models to continually refine and update their understanding of the network's behavior. Conversely, the insights from the ML and/or AI models may inform the constraints and parameters used in the optimization models, potentially improving their effectiveness in handling real-time data.

The integration of ML and/or AI models and optimization models within the enhanced ETA model 125 may also allow for more handling of uncertainty and variability in ETA predictions. The system may generate not just point estimates for arrival times, but also confidence intervals or probability distributions, providing a more nuanced view of potential ETA scenarios.

In embodiments, the system 100 may include or interact with a static ETA calculator 128. In some embodiments, the static ETA calculator 128 may be integrated within the system 100 or may exist as an external system. The static ETA calculator 128 may be configured to generate a static timestamp representing an estimated ETA for a train arriving at a particular destination, which may include a station.

In embodiments, the static ETA calculator 128 may have limited visibility in terms of its prediction capabilities. In some embodiments, the static ETA calculator 128 may only be able to predict ETAs within a threshold window of time. For example, the static ETA calculator 128 may be limited to predicting ETAs that are within the next X time period (e.g., within the next 8 hours, as a non-limiting example). Consequently, the static ETA calculator 128 may not be able to provide ETA predictions for arrival events beyond this X time period window.

In some embodiments, the enhanced ETA model 125 may utilize the output of the static ETA calculator 128 to augment the functionality of the static ETA calculator 128 and/or the enhanced ETA model 125. While the static ETA calculator 128 may be constrained to near-term predictions, the enhanced ETA model 125 may be capable of predicting ETAs (as a dynamic time window) that extend beyond the X time period limitation of the static ETA calculator 128.

In some embodiments, the enhanced ETA model 125 may employ a two-step process for generating enhanced ETAs. The static ETA calculator 128 may first be used to estimate a static ETA (e.g., as a timestamp) for the arrival of the train at a station. Subsequently, the enhanced ETA model 125 may generate the enhanced ETA based on this predicted static ETA at the station, incorporating additional factors such as the dwell time at the station and the travel time between the station and the final destination.

This functionality may allow the system to leverage the strengths of both the static ETA calculator 128 and the enhanced ETA model 125. The static calculator may provide initial near-term predictions, while the enhanced model may extend and refine these predictions, potentially offering more comprehensive and accurate ETAs over longer time horizons.

In some embodiments, the enhanced ETA generated by the enhanced ETA model 125 may be fed back to the static ETA calculator 128, which may use this information to refine its own predictions. This feedback loop may allow the static ETA calculator 128 to benefit from the more comprehensive and dynamic predictions of the enhanced ETA model 125. By incorporating this feedback, the static ETA calculator 128 may improve its accuracy for near-term predictions, even within its limited 8-hour window.

In embodiments, the enhanced ETA model 125 may include at least two models, a station dwell time model and a train travel time model. In embodiments, the station dwell time model may be implemented and managed by the dwell time model manager 121 and the train time travel model may be implemented and managed by the travel time model manager 122.

The station dwell time model may be configured to forecast the duration a train spends within a station, referred to as the dwell time. This predicted dwell time may represent the interval between a train's arrival at and departure from a station. The enhanced ETA model 125 may utilize this dwell time prediction, in conjunction with the train's arrival time at the station, to estimate the train's departure time.

In some embodiments, the enhanced ETA model 125 may predict the enhanced ETA of the train at its destination by estimating the train's departure time from the station, as well as the estimated travel time from the station to the destination as predicted by the train travel time model.

The station dwell time model may process data from various data signals related to factors that may affect or influence a train's duration within the station. Using this information, the station dwell time model may generate an estimated station dwell time for a specific train, indicating the train's expected stay within the station. The station dwell time model may ingest data from multiple sources, including but not limited to the train event table structure, train schedule table structure, train consist table structure, and train lineup table structure, as well as other relevant data structures that may impact dwell time calculations.

In some embodiments, the data in the data signals ingested by the station dwell time model may include one or more of a collection of events and/or a sequence of events. In some embodiments, one or more of the collection of events and/or a sequence of events may represent a triggering event that causes other events to take place. These events may include a train arrival event, a planned inspection event, a planned car setout, a planned car pickup, a planned locomotive change, an inspection start event, a car setout start event, a car pickup start event, a locomotive add/cut start event, an inspection complete event, a car setout complete event, a car pickup complete event, a locomotive add/cut complete event, a crew call time event, and a train departure event. The station dwell time model may ingest these data and may generate an estimated or actual train departure time.

In some embodiments, the enhanced ETA model 125 may use the estimated station dwell time from the station dwell time model to determine the train's departure time from the station. This estimated departure time, combined with other relevant data such as projected travel time, may be used to generate the enhanced ETA for the train's arrival at its final destination.

In embodiments, when predicting dwell time, the station dwell time model may take into account a variety of factors. These may include scheduled inspections, ongoing maintenance activities, station congestion levels, specific characteristics of the train consist, etc. In this manner, the station dwell time model may generate accurate predictions of station dwell times.

The train travel time model may be configured to predict the expected time of travel for a train from a source to a destination. In some embodiments, the train travel time model may estimate how long it may take for the train to travel from the current station to the destination, which may include another station. The train travel time model may ingest data included in data signals that are related to various factors that may affect the travel time of the train between stations.

In some embodiments, the train travel time model may process data from multiple sources to generate its predictions. These data signals may include, but are not limited to, train event signals and train schedule event signals. For example, the model may ingest data from the train event table structure, the train departure event table structure, and the train destination schedule table structure, among others. The train travel time model may also consider other data sources not explicitly described herein but that may affect the travel time of a train. These may include real-time weather data, track condition reports, information about other trains on the same route that might impact travel times, etc.

In some embodiments, the train travel time model may analyze historical travel time data for similar routes and conditions to refine its predictions. This historical analysis may allow the train travel time model to account for patterns or trends that may not be immediately apparent from current data alone. The train travel time model may also consider the specific characteristics of the train itself when making travel time predictions. For example, the train travel time model may take into account factors such as the train's maximum speed, the train's acceleration and deceleration capabilities, the train's length, etc., which may affect the train's performance on different track segments.

In some embodiments, the train travel time model may be configured to update the travel time predictions in real-time as new data becomes available. For example, if a delay occurs at an intermediate station, the train travel time model may adjust its travel time estimate for the remainder of the journey accordingly.

In some embodiments, the train travel time model may generate a table of estimated events for each train ID (TRN_ID). This table, as shown in Table 1 below, may include several key time estimates for each train's journey.

TABLE 1
Estimated Train Times

| TRN_{—} | STN_{—} | STN_{—} | STN_{—} | DES_{—} | SYS_{—} | DES_{—} |
|---|---|---|---|---|---|---|
| ID | TA | TD | ETD | ETA | DT_TM | TA |
| A | 9:05 | NAN | 15:10 | 20:10 | 9:10 | NAN |
| B | 7:31 | NAN | 9:30 | 12:40 | 9:10 | NAN |
| C | 8:00 | 9:05 | 9:05 | 12:40 | 9:10 | NAN |

For example, the model may estimate the station train arrival time (STN_TA), which may indicate the scheduled time at which the train is expected to arrive at the station. Additionally, the table may include the station scheduled departure time (STN_TD), representing the initially planned time for the train to leave the station.

The train travel time model may also incorporate data from the dwell time model to provide an estimated station departure time (STN_ETD). This estimate may differ from the scheduled departure time, taking into account various factors that may affect the train's actual departure from the station. The table may also include an estimated destination arrival time (DES_ETA), indicating when the train is predicted to reach its final destination, and a scheduled arrival time at the destination (DES_TA).

In some embodiments, the train travel time model may continuously update this table of estimated events as new data becomes available. For example, if a train experiences a delay at an earlier station, the model may adjust all subsequent time estimates for that train ID. In some cases, the train travel time model may also include confidence intervals or probability distributions for each estimated time in the table.

In embodiments, the enhanced ETA model 125 may generate the enhanced ETA by combining the predicted dwell time from the station dwell time model and the predicted train travel time from the train travel time model. For example, the station dwell time model may be used to determine how long a train will remain within a station. This prediction may include both the arrival time at the station and the departure time from the station. Once the dwell time has been estimated, the enhanced ETA model 125 may combine this information with the travel time prediction from the train travel time model. The travel time prediction may indicate how long the train will take to reach its final destination from the current station. By integrating these two pieces of information, the enhanced ETA model 125 may generate a more accurate overall prediction. For example, if the enhanced ETA model 125 knows that a train will arrive at a station at 2:00 PM, remain there for approximately two hours based on the dwell time prediction, and then take approximately three hours to reach its final destination based on the travel time prediction, the enhanced ETA model 125 may generate an enhanced ETA that may include a time window that includes approximately 7:00 PM for the train's arrival at its final destination. The time window may be a range that includes the 7:00 PM prediction (e.g., a time window of anywhere between a ten minute time window to an 8 hour time window).

In embodiments, the train travel time model may address the challenge of scarce data in train arrival predictions by employing a segment-based approach. This method may help overcome the limitations presented by the relatively few data points available for specific routes in a train network, which can make traditional model training difficult or impractical.

The segment-based approach may involve treating each route as a collection of smaller segments. In this context, a segment may represent a portion of the overall route, such as the distance between two stations or other defined points along the track. By breaking down routes into segments, the train travel time model may effectively increase the number of data points available for analysis and prediction.

In some embodiments, each segment may be considered a distinct data point. When a train travels along a particular segment, it may generate a new data point that can be used to train the train travel time model. This approach may significantly increase the volume of usable data, as multiple trains traveling different routes may contribute data points for shared segments.

The train travel time model may utilize these segment-based data points to train its predictive algorithms. By focusing on segments rather than complete routes, the model may be able to learn patterns and trends more effectively, even when data for specific end-to-end routes is limited.

When predicting the travel time for a specific route, the train travel time model may estimate the travel time for each segment that comprises the route. These segment-level predictions may be based on the train travel time model's training using the aggregated segment data points. The train travel time model may then combine the estimated travel times for all segments that overlap with the desired route to generate an overall travel time prediction.

In some embodiments, this segment-based approach may allow the train travel time model to provide more accurate and reliable predictions, even for routes with limited historical data. By leveraging data from multiple trains across shared segments, the train travel time model may be able to account for various factors that influence travel times, such as track conditions, typical speeds, and potential bottlenecks.

The segment-based method may also offer flexibility in handling route variations or new routes. If a new route is introduced, the train travel time model may still be able to provide predictions by analyzing the individual segments that make up the new route, even if no train has yet traveled the entire route.

In some embodiments, the train travel time model may be configured to continuously and/or periodically refine its segment-based predictions as new data becomes available. Each train journey may provide updated data points for the segments it travels, potentially improving the accuracy of future predictions for those segments and, by extension, any routes that include them.

This approach to handling scarce data may enable the enhanced ETA model 125 to provide more robust and accurate travel time predictions, potentially improving the overall reliability of the enhanced ETA system 150. By addressing the challenges posed by limited route-specific data, the segment-based approach implemented by the system of embodiments may contribute to more effective train scheduling, resource allocation, customer communication in rail transportation systems, accuracy in predictions, etc.

In embodiments, the enhanced ETA model 125 may use the estimated station dwell time and the estimated time travel to generate the enhanced ETA 123 for the train at the destination. The enhanced ETA is provided including a time window which indicates the time range at which the train is estimated to arrive at the destination.

The asset control manager 124 may be configured to generate and send control signals for managing and operating the physical asset 135 based on the enhanced ETA produced by the enhanced ETA model 125. In embodiments, the asset control manager 124 may analyze the enhanced ETA, which includes a dynamic time window, to determine optimal timing and positioning for the physical asset 135 and may generate the control signals based on the analysis.

The control signals generated by the asset control manager 124 may be electronic instructions or commands sent to the physical asset 135. These signals may contain specific directives for movement, routes, operation, and/or positioning of the asset. In some embodiments, the control signals may be transmitted wirelessly or through a wired connection (e.g., via network 145), depending on the communication capabilities of the physical asset 135.

The physical asset 135 may represent various types of equipment used in rail operations, such as locomotives, hostlers, cranes, and/or other machinery involved in loading, unloading, and/or transporting freight. These physical assets may be equipped with actuators, motors, engines, and/or other mechanisms that allow them to move or operate in response to the received control signals.

In some cases, the asset control manager 124 may use the enhanced ETA to generate a control signal that instructs the physical asset 135 to move from one location to another. This movement may be based on the dynamic time window provided by the enhanced ETA. For example, if the enhanced ETA indicates that a train is expected to arrive earlier than initially expected, the asset control manager 124 may send a control signal to move a crane or loading equipment to the appropriate location in preparation for the train's arrival.

The asset control manager 124 may also utilize the increasing accuracy of the enhanced ETA as the actual arrival time approaches. As the dynamic time window narrows and becomes more precise closer to the actual ETA, the asset control manager 124 may generate more refined control signals, allowing for more efficient positioning and operation of the physical asset 135.

In some embodiments, the asset control manager 124 may use the enhanced ETA to make corrective actions. For example, if the enhanced ETA is modified to indicate a delay, the asset control manager 124 may generate a control signal to move the physical asset 135 to a different location where it can be utilized more effectively, rather than allowing it to remain idle at its original position.

In some embodiments, the control signals generated by the asset control manager 124 may be used for manual control of the physical asset 135. For example, the control signals may be interpreted and acted upon by human operators. For example, the control signal may be displayed on a user interface, providing guidance to an operator on how to manually position or operate the physical asset 135 based on the enhanced ETA.

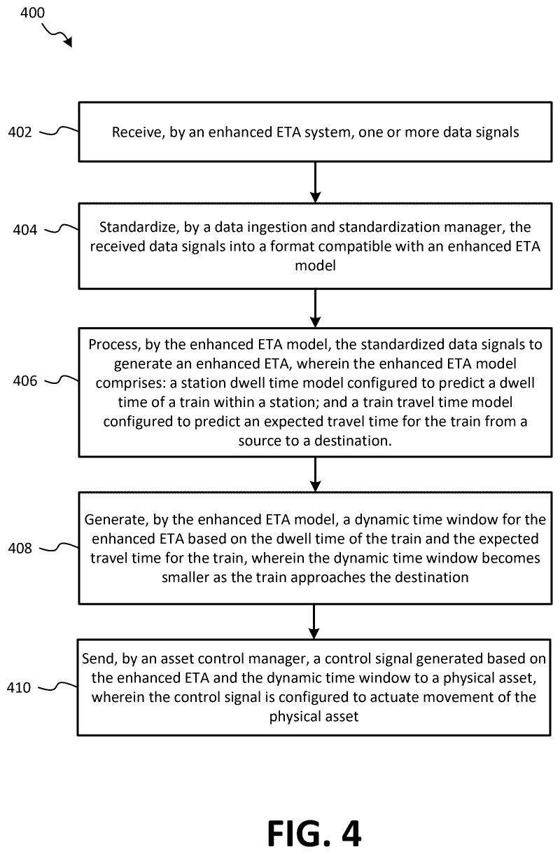

FIG. 4 shows a high-level flow diagram 400 of operation of a system configured for providing functionality for analyzing track geometry data for track monitoring and defect detection in accordance with embodiments of the present disclosure. For example, the functions illustrated in the example blocks shown in FIG. 4 may be performed by system 100 of FIG. 1 according to embodiments herein. In embodiments, the operations of the method 400 may be stored as instructions that, when executed by one or more processors, cause the one or more processors to perform the operations of the method 400.

At block 402, one or more data signals are received. In embodiments, functionality of a data ingestion and standardization manager (e.g., data ingestion and standardization manager 120 as illustrated in FIG. 2) may be used receive the one or more data signals. In embodiments, the data ingestion and standardization manager may perform operations to receive one or more data signals according to operations and functionality as described above with reference to data ingestion and standardization manager 120 and as illustrated in FIGS. 1-3F.

At block 404, the received data signals are standardized into a format compatible with an enhanced ETA model. In embodiments, functionality of a data ingestion and standardization manager (e.g., data ingestion and standardization manager 120 as illustrated in FIG. 2) may be used to standardize the received data signals into a format compatible with an enhanced ETA model. In embodiments, the data ingestion and standardization manager may perform operations to standardize the received data signals into a format compatible with an enhanced ETA model according to operations and functionality as described above with reference to data ingestion and standardization manager 120 and as illustrated in FIGS. 1-3F.

At block 406, the standardized data signals are processed to generate an enhanced ETA. In embodiments, functionality of an enhanced ETA model (e.g., enhanced ETA model 125 as illustrated in FIG. 2) may be used to process the standardized data signals to generate an enhanced ETA. In embodiments, the enhanced ETA model may comprise a station dwell time model configured to predict a dwell time of a train within a station and a train travel time model configured to predict an expected travel time for the train from a source to a destination. In embodiments, the enhanced ETA model may perform operations to process the standardized data signals to generate an enhanced ETA according to operations and functionality as described above with reference to the enhanced ETA model 125 and as illustrated in FIGS. 1-3F.

At block 408, a dynamic time window for the enhanced ETA is generated based on the dwell time of the train and the expected travel time for the train. In embodiments, the dynamic time window becomes smaller as the train approaches the destination. In embodiments, functionality of an enhanced ETA model (e.g., enhanced ETA model 125 as illustrated in FIG. 2) may be used to generate a dynamic time window for the enhanced ETA based on the dwell time of the train and the expected travel time for the train. In embodiments, the enhanced ETA model may perform operations to generate a dynamic time window for the enhanced ETA based on the dwell time of the train and the expected travel time for the train according to operations and functionality as described above with reference to the enhanced ETA model 125 and as illustrated in FIGS. 1-3F.

At block 410, a control signal generated based on the enhanced ETA and the dynamic time window is sent to a physical asset. In embodiments, the control signal is configured to actuate movement of the physical asset. In embodiments, functionality of an asset control manager (e.g., asset control manager 124 as illustrated in FIG. 2) may be used to send a control signal generated based on the enhanced ETA and the dynamic time window to a physical asset. In embodiments, the asset control manager may perform operations to send a control signal generated based on the enhanced ETA and the dynamic time window to a physical asset according to operations and functionality as described above with reference to the asset control manager 124 and as illustrated in FIGS. 1-3F.

Persons skilled in the art will readily understand that advantages and objectives described above would not be possible without the particular combination of computer hardware and other structural components and mechanisms assembled in this inventive system and described herein. Additionally, the algorithms, methods, and processes disclosed herein improve and transform any general-purpose computer or processor disclosed in this specification and drawings into a special purpose computer programmed to perform the disclosed algorithms, methods, and processes to achieve the aforementioned functionality, advantages, and objectives. It will be further understood that a variety of programming tools, known to persons skilled in the art, are available for generating and implementing the features and operations described in the foregoing. Moreover, the particular choice of programming tool(s) may be governed by the specific objectives and constraints placed on the implementation selected for realizing the concepts set forth herein and in the appended claims.

The description in this patent document should not be read as implying that any particular element, step, or function can be an essential or critical element that must be included in the claim scope. Also, none of the claims can be intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S.C. § 112(f). Even under the broadest reasonable interpretation, in light of this paragraph of this specification, the claims are not intended to invoke 35 U.S.C. § 112(f) absent the specific language described above.

The disclosure may be embodied in other specific forms without departing from the spirit or essential characteristics thereof. For example, each of the new structures described herein, may be modified to suit particular local variations or requirements while retaining their basic configurations or structural relationships with each other or while performing the same or similar functions described herein. The present embodiments are therefore to be considered in all respects as illustrative and not restrictive. Accordingly, the scope of the disclosure can be established by the appended claims. All changes which come within the meaning and range of equivalency of the claims are therefore intended to be embraced therein. Further, the individual elements of the claims are not well-understood, routine, or conventional. Instead, the claims are directed to the unconventional inventive concept described in the specification.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various embodiments of the present disclosure may be combined or performed in ways other than those illustrated and described herein.

Functional blocks and modules in FIGS. 1-6 may comprise processors, electronics devices, hardware devices, electronics components, logical circuits, memories, software codes, firmware codes, etc., or any combination thereof. Consistent with the foregoing, various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal, base station, a sensor, or any other communication device. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method by a computing system for generating an enhanced estimated time of arrival (ETA) with a dynamic time window for last-mile delivery, the method comprising:
receiving, by an enhanced ETA system, one or more data signals;
standardizing, by a data ingestion and standardization manager, the received data signals into a format compatible with an enhanced ETA model;
processing, by the enhanced ETA model, the standardized data signals to generate an enhanced ETA, wherein the enhanced ETA model comprises:
a station dwell time model configured to predict a dwell time of a train within a station; and
a train travel time model configured to predict an expected travel time for the train from a source to a destination;
generating, by the enhanced ETA model, a dynamic time window for the enhanced ETA based on the dwell time of the train and the expected travel time for the train, wherein the dynamic time window becomes smaller as the train approaches the destination; and
sending, by an asset control manager, a control signal generated based on the enhanced ETA and the dynamic time window to a physical asset, wherein the control signal is configured to actuate movement of the physical asset.

2. The method of claim 1, wherein the one or more data signals include at least one of historical data signals, projected traffic signals, and real-time signals.

3. The method of claim 2, wherein the projected traffic signals include one or more of scheduled train arrival events, scheduled inspection data, station congestion data, and train consist data.

4. The method of claim 2, wherein the real-time signals include one or more of a real-time train location, real-time maintenance data, real-time weather data, and real-time track condition data.

5. The method of claim 1, wherein standardizing the received data signals includes:
converting the received data signals into one or more standardized model structures, wherein the one or more standardized model structures include one or more of a train event table structure, a train schedule event table structure, a train consist table structure, and a train lineup table structure.

6. The method of claim 1, wherein the configuration of the train travel time model to predict the expected travel time for the train includes configuration for:
dividing a route of the train into a plurality of segments;
predicting a segment travel time for each of the plurality of segments; and
combining the segment travel time for each of the plurality of segments to predict the expected travel time for the train.

7. The method of claim 1, wherein the configuration of the station dwell time model to predict the dwell time of the train includes configuration to predict the dwell time of the train based on a real-time location of the train within the station and one or more scheduled events, wherein the one or more scheduled events include one or more of a planned inspection, a planned car setout, and a planned car pickup.

8. The method of claim 1, wherein the dynamic time window includes a 12-hour time window when the train is a first distance from the destination, a 4-hour time window when the train is a second distance from the destination closer than the first distance, and a 2-hour time window when the train is a third distance from the destination closer than the second distance.

9. The method of claim 1, wherein the physical asset includes one or more of a locomotive, a hostler, a truck, a crane, loading equipment, and any movable equipment used in rail transportation operations.

10. The method of claim 1, further comprising:
receiving a static ETA from a static ETA calculator, the static ETA including a single timestamp, wherein processing the standardized data signals to generate the enhanced ETA is further based on the static ETA.

11. A system for generating an enhanced estimated time of arrival (ETA) with a dynamic time window for last-mile delivery, the system comprising:
at least one processor; and
a memory operably coupled to the at least one processor and storing processor-readable code that, when executed by the at least one processor, is configured to perform operations comprising:
receiving, by an enhanced ETA system, one or more data signals;
standardizing, by a data ingestion and standardization manager, the received data signals into a format compatible with an enhanced ETA model;
processing, by the enhanced ETA model, the standardized data signals to generate an enhanced ETA, wherein the enhanced ETA model comprises:
a station dwell time model configured to predict a dwell time of a train within a station; and
a train travel time model configured to predict an expected travel time for the train from a source to a destination;
generating, by the enhanced ETA model, a dynamic time window for the enhanced ETA based on the dwell time of the train and the expected travel time for the train, wherein the dynamic time window becomes smaller as the train approaches the destination; and
sending, by an asset control manager, a control signal generated based on the enhanced ETA and the dynamic time window to a physical asset, wherein the control signal is configured to actuate movement of the physical asset.

12. The system of claim 11, wherein the one or more data signals include at least one of historical data signals, projected traffic signals, and real-time signals.

13. The system of claim 12, wherein the projected traffic signals include one or more of scheduled train arrival events, scheduled inspection data, station congestion data, and train consist data.

14. The system of claim 12, wherein the real-time signals include one or more of a real-time train location, real-time maintenance data, real-time weather data, and real-time track condition data.

15. The system of claim 11, wherein standardizing the received data signals includes:
converting the received data signals into one or more standardized model structures, wherein the one or more standardized model structures include one or more of a train event table structure, a train schedule event table structure, a train consist table structure, and a train lineup table structure.

16. The system of claim 11, wherein the configuration of the train travel time model to predict the expected travel time for the train includes configuration for:
dividing a route of the train into a plurality of segments;
predicting a segment travel time for each of the plurality of segments; and
combining the segment travel time for each of the plurality of segments to predict the expected travel time for the train.

17. The system of claim 11, wherein the configuration of the station dwell time model to predict the dwell time of the train includes configuration to predict the dwell time of the train based on a real-time location of the train within the station and one or more scheduled events, wherein the one or more scheduled events include one or more of a planned inspection, a planned car setout, and a planned car pickup.

18. The system of claim 11, wherein the dynamic time window includes a 12-hour time window when the train is a first distance from the destination, a 4-hour time window when the train is a second distance from the destination closer than the first distance, and a 2-hour time window when the train is a third distance from the destination closer than the second distance.

19. The system of claim 11, further comprising:
receiving a static ETA from a static ETA calculator, the static ETA including a single timestamp, wherein processing the standardized data signals to generate the enhanced ETA is further based on the static ETA.

20. A computer-based tool for generating an enhanced estimated time of arrival (ETA) with a dynamic time window for last-mile delivery including non-transitory computer readable media having stored thereon computer code which, when executed by a processor, causes a computing device to perform operations comprising:
receiving, by an enhanced ETA system, one or more data signals;
standardizing, by a data ingestion and standardization manager, the received data signals into a format compatible with an enhanced ETA model;
processing, by the enhanced ETA model, the standardized data signals to generate an enhanced ETA, wherein the enhanced ETA model comprises:
a station dwell time model configured to predict a dwell time of a train within a station; and
a train travel time model configured to predict an expected travel time for the train from a source to a destination;
generating, by the enhanced ETA model, a dynamic time window for the enhanced ETA based on the dwell time of the train and the expected travel time for the train, wherein the dynamic time window becomes smaller as the train approaches the destination; and
sending, by an asset control manager, a control signal generated based on the enhanced ETA and the dynamic time window to a physical asset, wherein the control signal is configured to actuate movement of the physical asset.
